(19) United States
(12) Patent Application Publication
(10) Pub. No.: US 2008/0176972 A1
(43) Pub. Date: Jul. 24, 2008

(54) Radiation cured elastomeric urethane acrylate films and the process for making same

(76) Inventors: David Hews, Belchertown, MA (US); John Delude, Belchertown, MA (US); Leo Moreau, Broad Brook, CT (US); Dzu Luong, West Hartford, CT (US); Edward D. Phillips, Oakville, CT (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/655,753

(22) Filed: Jan. 19, 2007

(51) Int. Cl. C08F 2/46

(52) U.S. Cl. 522/33

(57) ABSTRACT

A radiation-cured, elastomeric, urethane acrylate polymer has an elongation at break of between 100% (50) and 400% and a film break strength of between 200 and 2,600 psi at a thickness between about 0.002 inches and 0.010 inches.

### BACKGROUND OF THE INVENTION

Plasticized polyvinyl chloride (PVC) films are used for numerous applications due to their flexibility, strength and cost. These films show problems with high temperature stability as well as plasticizer migration to the film surface and out of the film structure. As the PVC films age they become more rigid and break more easily. Polyolefin films without plasticizer remain flexible over time but also show problems with dimensional stability and flexibility at elevated temperatures. Lightly cross-linked polyurethanes are also flexible. However, they can be tacky and cannot be easily handled at normal room temperatures and humidities. Highly cross-linked polyurethane films are rigid.

As a result, there is no known polymer structure that remains flexible at elevated temperatures without tack problems. Polyurethanes dried from solvent-based systems show issues with blistering at film thickness high enough to make them usable as stand alone films.

### SUMMARY OF THE INVENTION

In one embodiment, the present invention is an elastomeric urethane acrylate polymer film.

In another embodiment, the present invention is a method of manufacturing an elastomeric urethane acrylate polymer film. The method comprises a step of curing (a pre-polymer) by radiation. The pre-polymer comprises multifunctional urethane acrylate monomeric or oligomeric subunits and monofunctional and multifunctional (meth)acrylate monomeric or oligomeric subunits.

In another embodiment, the present invention is a method of manufacturing an optical structure that includes an elastomeric urethane acrylate polymer film, and a layer of prismatic retroreflective structures attached to said urethane acrylate polymer film. The method comprises a step of radiation curing a pre-polymer that includes multifunctional urethane acrylate monomeric of oligomeric subunits and monofunctional and multifunctional (meth)acrylate monomeric or oligomeric subunits.

### DETAILED DESCRIPTION OF THE INVENTION

To address these issues, an intermediate thickness (0.005 inches preferably) radiation cured urethane acrylate (UA) film that is flexible and elastomeric without addition of the plasticizers has been developed. The film can remain flexible with repeated exposure to heat and aging. It does not deform the way comparable PVC and polyolefin films do at elevated temperature. The film can be designed over a range of elasticity and tack properties by adjusting the functionality or level of monofunctional and multifunctional oligomers and monomers in the uncured formulae.

As used herein, the term “film” refers to a self-supporting sheet. The term “coating” refers to a non-self-supporting layer of material attached to a film.

As used herein, “pre-polymer” refers to the mixture of the monomers, oligomers and other additives, which, upon polymerization, including curing, produce a polymer.

A radiation-cured, elastomeric, urethane acrylate polymer has an elongation at break of between 100% and 400% and a film break strength of between 500 and 2,600 psi. at a thickness between about 0.002 inches and 0.010 inches.

The pre-polymer is extruded onto an untreated polyethylene terephthalate, release treated polyethylene terephthalate (including silicon release treated) or polyethylene terephthalate coated with other layers to import surface properties to the finished film.

The pre-polymer can be applied to the PET carrier employing one of the following: slot die, curtain, 2-roll reverse, and 3-roll reverse coating methods.

The polymer is radiation cured in air, nitrogen gas, carbon dioxide or under a clear protective laminate, such as, e.g., polyethylene terephthalate.

The pre-polymer can include a photoinitiator that is employed to change surface as compared to bulk cure characteristics. Examples of the suitable photoinitiators include but are not limited to: the alpha-hydroxy ketone class, such as Irgacure 184™ (1-Hydroxycyclohexyl phenyl ketone) available from Ciba-Geigy® or Lamberti® KIP 150™, available from Lamberti under catalog number KIP 150; benzophenones, such as Aldrich Catalog #427551; amine synergists, such as Sartomer CN-373 or CN-386, available under the catalog numbers CN-373; and triphosphene oxides, such as Bis(2,4,6-trimethylbenzoyl)-phenyl phosphine oxide, available from Ciba-Geigy as Irgacure 819™ or as contained in Ciba-Geigy Darocure 4265™, available under the catalog number Darocure 4265.

A photoinitiator can be included in a ration of 1-10%, preferably, 2-8% of the final mixture (by weight).

The pre-polymer can include monofunctional and/or multifunctional oligomers and monomers to control tack and elasticity of the final design. The film comprises multifunctional urethane acrylate monomeric or oligomeric subunits and monofunctional and multifunctional (meth)acrylate monomeric or oligomeric subunits.

Examples of the multifunctional urethane acrylate monomeric or oligomeric subunits oligomers include, but are not limited to urethane acrylates, such as Bomar® BR-5825, BR-7432G, BR-446, BR-970, BR-3641AA, BR-541, BR-7632G, BR-372, BR-374, or melamine acrylates, such as Bomar BMA-200. Another example of urethane acrylate resin that can be used in the present invention is Sartomer® CN-991.

Examples of the monofunctional and multifunctional (meth)acrylate monomeric or oligomeric subunits include, but are not limited to the following resins available from Sartomer®: SR-506 (Isobornyl Acrylate), SR-399 (Dipentaerythritol Pentacrylate), SR-444 (Pentaerythritol Triacrylate), SR-454 (Ethyoxylated (3) trimethylolpropane triacrylate), and CD-560 (Alkoxylated Hexanediol diacrylate).

Preferably, the polymer comprises a blend of a first type of urethane acrylate monomeric or oligomeric subunits and a second type of urethane acrylate monomeric or oligomeric subunits. The first type forms the bulk of the polymeric material, while a lesser amount of the second type is included in the pre-polymer to adjust polymer film properties. Examples of the first type include BR-5825, BR-7432G, BR-3641AA, and BR-7632G. The remainder of the urethane acrylate monomers/oligomers listed above typically comprises the second type. Typically, the weight percent of the second type of urethane acrylate monomers/oligomers in the blend is from about 0% to about 15%, preferably, 0% to about 7%.

Preferably, the weight percent ratio of monofunctional and multifunctional (meth)acrylate monomeric or oligomeric subunits to the first type of urethane acrylate monomeric or oligomeric subunits is from about 10:90 to about 60:40, preferably about 20:80 to about 40:60.

The pre-polymer can include a surfactant to improve deaeration and leveling of the coating lacquer and film surface characteristics. Suitable surfactants can be selected from but are not limited to such fluorosurfactants as Dupont® Zonyl™ FSN (Telomer B Monoether with Polyethylene Glycol), Zonyl 9631 (a blend of three Telomer B Phosphate Diethanolamine Salts), and AirProducts® Surfynol™ 420 (a blend of 2,4,7,9-tetramethyl-5-decyne-4,7-diol and ethoxylated 2,4,7,9-tetramethyl-5-decyne-4,7-diol).

A stabilizing agent to reduce lacquer yellowing with heat and age can be included in the pre-polymer. The stabilizing agent can include, but are not limited to, Dove Chemical HiPure4 (Trisnonylphenol phosphite) and Irganox 1010 from Ciba-Geigy which is 2,2-bis[[3-[3,5-bis(1,1-Dimethylethyl)-4-hydroxyphenyl]-1-oxopropoxy]methyl]-1,3-propanediyl 3,5-bis(1,1-dimethyl-ethyl)-4-hydroxybenzenepropanoate.

A solvent is preferably used during the manufacturing of the film of the present invention to dilute the oligomer and monomer solution to allow more uniform coating application. Typically, methyl ethyl ketone, ethyl acetate or toluene are used.

In one embodiment, prismatic retroreflective elements are applied subsequent to the formation of the film. The resulting film shows an elongation at break of between 10% and 250% at a thickness between 0.0035 inches and 0.013 inches. The film and retroreflective elements can be formed at the same radiation curing step or in a separate curing process. The retroreflective elements can be metalized and formed into a retroreflective garment tape.

The pre-polymer can be dyed and/or pigmented by addition of a colorant to provide different film colors. Examples of suitable colorants include but not limited to Solvent Yellow 98 dye and C.I. Pigment Yellow 151 such as Ciba-Geigy Microlith Yellow 4G-K. Hindered Amine Light Stabilizers are used with the colorants for example Tinuvin 123 from Ciba-Geigy and/or UV light stabilizers for example Tinuvin 460 from Ciba-Geigy.

The film can be cured at thickness at least up to about 0.010 inches without blistering or significant shrinkage problems. The films can be cured under an inert nitrogen gas or carbon dioxide gas system or in air. The films are made by coating monomers, oligomers and photoinitiators employing slot dye, reverse roll, between the roll (BTR), or any other method that can provide the necessary wet thickness and then subsequent radiation curing. Since the cured film does not shift properties over time and exposure, it can be made slightly less flexible than comparable PVC films allowing a thinner overall structure for the same performance. Retroreflective elements can be applied to the new film or formed in situ during film formation.

The retroreflective structure can be formed by numerous methods in combination with the presently disclosed embodiments. Some of the methods for forming a retroreflective structure are disclosed in U.S. Pat. No. 3,684,348, issued to Rowland on Aug. 15, 1972; U.S. Pat. No. 3,689,346, issued to Rowland on Sep. 5, 1972; U.S. Pat. No. 3,811,983, issued to Rowland on May 21, 1974; U.S. Pat. No. 3,830,682, issued to Rowland on Aug. 20, 1974; U.S. Pat. No. 3,975,083, issued to Rowland on Aug. 17, 1976; U.S. Pat. No. 4,332,847, issued to Rowland on Jun. 1, 1982; U.S. Pat. No. 4,801,193, issued to Martin on Jan. 31, 1989; U.S. Pat. No. 5,229,882, issued to Rowland on Jul. 20, 1993; U.S. Pat. No. 5,236,751, issued to Martin et al. on Aug. 17, 1993; U.S. Pat. No. 5,264,063, issued to Martin on Nov. 23, 1992; U.S. Pat. No. 5,376,431, issued to Rowland on Dec. 27, 1994; U.S. Pat. No. 5,491,586, issued to Phillips on Feb. 13, 1996; U.S. Pat. No. 5,512,219, issued to Rowland on Apr. 30, 1996; U.S. Pat. No. 5,558,740, issued to Bernard et al. on Sep. 24, 1996; U.S. Pat. No. 5,592,330, issued to Bernard on Jan. 7, 1997; U.S. Pat. No. 5,637,173, issued to Martin et al. on Jun. 10, 1997; U.S. Pat. No. 3,712,706, issued to Stamm on Jan. 23, 1973; U.S. Pat. No. 3,684,348, issued to Rowland, Aug. 15, 1972; U.S. Pat. No. 5,786,066, issued to Rowland, Jul. 28, 1998; U.S. Pat. No. 6,143,224, issued to Bernard et al. Nov. 7, 2000; and U.S. Pat. No. 5,565,151, issued to Nilsen on Oct. 15, 1996. The entire teachings of each of the preceding patents are incorporated herein by reference.

The elastomeric urethane acrylate film of the present invention can be used for a number of applications, including for manufacturing a retroreflective garment tape.

Accordingly, in one embodiment, the present invention is a method of manufacturing an optical structure that includes an elastomeric urethane acrylate polymer layer, and a layer of prismatic retroreflective structures attached to the urethane acrylate polymer layer. Preferably, the method comprises a step of radiation curing a pre-polymer that includes multifunctional urethane acrylate monomeric or oligomeric subunits and monofunctional and multifunctional (meth)acrylate monomeric or oligomeric subunits. Preferably, the elastomeric urethane acrylate polymer layer and layer of prismatic retroreflective structures are formed by the same radiation curing step.

The preferred embodiment of this design consists of a 4-layer structure. Detailed descriptions of each layer's construction, it's purpose and the process used for manufacture follows.

During a typical manufacturing process, a garment tape that employs an elastomeric urethane acrylate film of the present invention is produced by the following sequence of steps. Onto a PET carrier (Carrier 1), Layer #1 (dye block coating) is applied, followed by Layer #2 (elastomeric urethane acrylate film), and followed by another PET carrier (Carrier 2). In this configuration, the product may be rolled and shipped. Removal of Carrier 2 allows for the application of a prismatic layer (Layer #3). Layer #4 (aluminum) can be further applied to Layer #3. In this configuration (Layers #1 through 4 attached to Carrier 1), the product can be rolled and shipped. Finally and optionally, fabric and adhesive layers may be applied to aluminum layer (Layer #4) to form a garment tape. Carrier 1 is typically removed before end-user utilization of the product.

Typical compositions and methods of manufacturing of Layers #1 through 4 are described below. One of ordinary skill in the art will appreciate that specific details are determined by those practicing the present invention.

Layer #1 is a dye block coating. A dye block coating eliminates transfer of dye into the final structure during high temperature wash processes. Dyes can transfer either from the cloth upon which the retroreflective tape is sewn or between pieces of differently colored tape. A dye block layer is a protective polymeric coating made of polyether acrylate, aliphatic urethane acrylate, and (meth)acrylate monomers and oligomers. One of ordinary skill in the art of polymeric coating will understand how produce such a coating.

Layer #2 is an elastomeric, aliphatic, urethane acrylate film disposition. The second layer is applied on top of the dye block layer. It's purpose is to provide a substrate that will remain flexible through multiple wash, dry and wear cycles at high temperatures required for industrial laundering of safety garments.

To produce layer #2, the formulation described below was extruded onto dye block layer-coated PET using a slot dye coating process at 0.006″ thickness. Layer #2 was cured in air under 2 consecutive Mercury vapor UV (H) bulbs at 600 W/in power at 33 feet per minute. A silicone release coated 142 gauge PET film (Carrier #2) was laminated onto the film after curing to allow better conveyance and roll winding. The resulting structure measured 238% elongation when the carrier films are removed and a 1″ sample width is stretched at 12 in/min with 2″ of film between the tensile testing jaws.

A preferred embodiment of a formulation of a film of the present invention is provided below:

| Chemical Class | Chemical Name | Weight % |
|---|---|---|
| Difunctional Polyester Aliphatic Urethane | Bomar 7432G | 63.5 |
| Acrylate Oligomer (Trade Secret) | | |
| Monofunctional Acrylate Monomer | Sartomer SR506 | 30. |
| (Isoborynl Acrlyate) | | |
| 1-Hydroxycyclohexyl phenyl ketone | Ciba Irgacure 184 | 6. |
| Photoinitiator | | |
| Trisnonylphenol phosphite | Doverphos | 0.5 |
| | HiPure4 | |

Layer #3 is a layer of retroreflective prisms. The methods of manufacturing layers of retroreflective prisms are well known in the art.

Layer #4 is a layer of aluminum. The final layer in the structure were applied to the back of the retroreflective prisms in order to provide a reflective surface on the prisms once adhesives are added to make tapes. The layer was made of vacuum deposited metallic aluminum. The resultant film at this stage shows 250% elongation when the carrier film is removed and a 1″ sample width is stretched at 12 in/min with 2″ of film between the tensile testing jaws.

Once Layers #1 through 4 are applied, the film was ready to be made into garment tape. A pressure sensitive adhesive (PSA) is applied to the back of the structure (against the aluminum layer). To allow the product to be sewn to garments a fabric backing is laminated onto the PSA; at the same time Carrier #1 is removed. The resultant tape was flexible enough to withstand multiple high temperature wash, dry and wear cycles without significant changes in film properties.

What is claimed is:

1. An elastomeric urethane acrylate polymer film.

2. The film of claim 1, wherein the urethane acrylate polymer comprises:
multifunctional urethane acrylate monomeric or oligomeric subunits; and
monofunctional and multifunctional (meth)acrylate monomeric or oligomeric subunits.

3. The film of claim 2, wherein the urethane acrylate polymer comprises a blend of a first type of urethane acrylate monomeric or oligomeric subunits and a second type of urethane acrylate monomeric or oligomeric subunits.

4. The film of claim 3, wherein the weight percent of the second type of urethane acrylate monomers/oligomers in the polymer is from about 0% to about 15%.

5. The film of claim 3, wherein the weight percent ratio of monofunctional and multifunctional (meth)acrylate monomeric or oligomeric subunits to the first type of urethane acrylate monomeric or oligomeric subunits is from about 10:90 to about 60:40.

6. The film of claim 4, further including a photoinitiator.

7. The film of claim 6, wherein the weight percent of the photoinitiator in the polymer is from about 1% to about 10%.

8. The film of claim 6, wherein the photoinitiator is selected from alpha-hydroxy ketones, benzophenones, amine synergists, and triphosphene oxides.

9. The film of claim 6, further including a surfactant.

10. The film of claim 9, wherein said surfactant is one or more Telomer B Monoether with Polyethylene Glycol, Telomer B Phosphate Diethanolamine salts, 2,4,7,9-tetramethyl-5-decyne-4,7-diol, and ethoxylated 2,4,7,9-tetramethyl-5-decyne-4,7-diol).

11. The film of claim 9 further including a stabilizing agent.

12. The film of claim 11, wherein the stabilizing agent is one or more of trisnonylphenol phosphite or 2,2-bis[[3-[3,5-bis(1,1-Dimethylethyl)-4-hydroxyphenyl]-1-oxopropoxy]methyl]-1,3-propanediyl 3,5-bis(1,1-dimethyl-ethyl)-4-hydroxybenzenepropanoate.

13. The film of claim 11, further including a colorant.

14. An optical structure, comprising:
a urethane acrylate polymer film; and
a layer of prismatic retroreflective structures attached to said urethane acrylate polymer layer.

15. The structure of claim 14, wherein the urethane acrylate polymer layer shows an elongation at break of between 10% and 250% at a thickness between 0.0035 inches and 0.013 inches.

16. The structure of claim 14, wherein the polymer film further includes a colorant.

17. A method of manufacturing an elastomeric urethane acrylate polymer film, comprising a step of curing by radiation a pre-polymer, said pre-polymer comprising multifunctional urethane acrylate monomeric or oligomeric subunits and monofunctional and multifunctional (meth)acrylate monomeric or oligomeric subunits.

18. The method of claim 17, wherein the pre-polymer is radiation cured in air, nitrogen gas, carbon dioxide or under a clear protective laminate.

19. The method of claim 18, further including the step of extruding the pre-polymer onto a clear carrier film.

20. The method of claim 19, wherein the clear carrier film is an untreated polyethylene terephthalate.

21. The method of claim 19, wherein the clear carrier film is a silicone release treated polyethylene terephthalate.

22. The method of claim 19, wherein the clear carrier film is coated with a dye block layer.

23. A method of manufacturing an optical structure that includes an elastomeric urethane acrylate polymer film, and a layer of prismatic retroreflective structures attached to said urethane acrylate polymer film,
said method comprising a step of radiation curing a pre-polymer that includes multifunctional urethane acrylate monomeric or oligomeric subunits and monofunctional and multifunctional (meth)acrylate monomeric or oligomeric subunits.

24. The method of claim 23 wherein the elastomeric urethane acrylate polymer layer and layer of prismatic retroreflective structures are formed by the same radiation curing step.

25. The method of claim 23, further including a step of metalizing the layer of prismatic retroreflective structures.

26. The method of claim 25, further including a step of forming the optical structure into a retroreflective garment tape.
